(19) United States
(12) Patent Application Publication
(10) Pub. No.: US 2025/0344239 A1
(43) Pub. Date: Nov. 6, 2025

(54) RADIO RESOURCE ASSIGNMENT

(71) Applicant: QUALCOMM Incorporated, San Diego, CA (US)

(72) Inventors: Gaurang NAIK, San Diego, CA (US); George CHERIAN, San Diego, CA (US); Youhan KIM, Saratoga, CA (US); Naveen Kumar KAKANI, Flower Mound, TX (US); Jinsung LEE, San Jose, CA (US); Srinivas KATAR, Fremont, CA (US); Devesh SINGH, Bangalore (IN); Abhi SHIVAMURTHY, Bangalore (IN); Abhishek Pramod PATIL, San Diego, CA (US); Alfred ASTERJADHI, San Diego, CA (US); Sai Yiu Duncan HO, San Diego, CA (US)

(21) Appl. No.: 18/655,136

(22) Filed: May 3, 2024

(51) Int. Cl. H04W 72/563

(52) U.S. Cl. CPC H04W 72/563

(57) ABSTRACT

Aspects of the present disclosure provide methods for wireless communication at a wireless node, generally including detecting, while on a first primary channel, an event related to a second primary channel and performing one or more actions on at least one of the first primary channel or the second primary channel after detecting the event, the performance being based on at least one prioritization rule being satisfied.

### TECHNICAL FIELD

This disclosure relates generally to wireless communication, and more specifically, to rules for assigning radio resources.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some WLAN scenarios, devices share access to a wireless medium. In such scenarios, contention-based channel access is a mechanism used to share the wireless medium. This mechanism allows multiple devices to access the same wireless channel without a centralized coordinator, making it suitable for scenarios with a variable number of devices.

For example, devices that want to transmit data first listen to the wireless channel. This procedure is referred to as carrier sensing, where a device first checks if the channel is idle or busy. If the channel is sensed as busy, indicating another device is currently transmitting, the carrier sensing device will wait for an idle period before attempting to transmit.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication by a wireless node. The method includes detecting, while on a first primary channel, an event related to a second primary channel; and performing one or more actions on at least one of the first primary channel or the second primary channel after detecting the event, the performance being based on at least one prioritization rule being satisfied.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

The appended figures depict certain features of the various aspects described herein and are not to be considered limiting of the scope of this disclosure.

FIG. 1 shows a pictorial diagram of an example wireless communication network.

FIG. 2 shows a pictorial diagram of an example bandwidth configuration for a wireless local area network (WLAN).

FIGS. 3A and 3B show an example of primary and secondary channel selection for a given channel.

FIGS. 4A and 4B show examples of transmitter and receiver radio resources assignment.

FIG. 5 shows a diagram illustrating an example process, in accordance with aspects of the present disclosure.

FIG. 6 shows a diagram illustrating an example process, in accordance with aspects of the present disclosure.

FIG. 7 shows a flowchart illustrating an example process performable by or at a wireless node.

FIG. 8 shows a block diagram of an example wireless communication device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects of the present disclosure relate generally to wireless communication and more particularly to techniques for assigning radio resources. For example, the techniques may be used for radio resource switching for wireless nodes that support non-primary channel access (NPCA).

Contention-based channel access generally refers to a mechanism used to share the wireless medium. Devices that want to transmit data first listen to the wireless channel. This procedure is referred to as carrier sensing, where a device first checks if the channel is idle or busy. If the channel is sensed as busy, indicating another device is currently transmitting, the carrier sensing device will wait for an idle period before attempting to transmit.

Contention-based channel access may be used to share access in WLANs that support relatively large bandwidths. For example, IEEE 802.11be Extremely High Throughput (EHT), also known as Wi-Fi 7, has defined bandwidth support for up to 320 MHz. Within the large bandwidth, one 20 MHz channel is designated as a primary channel.

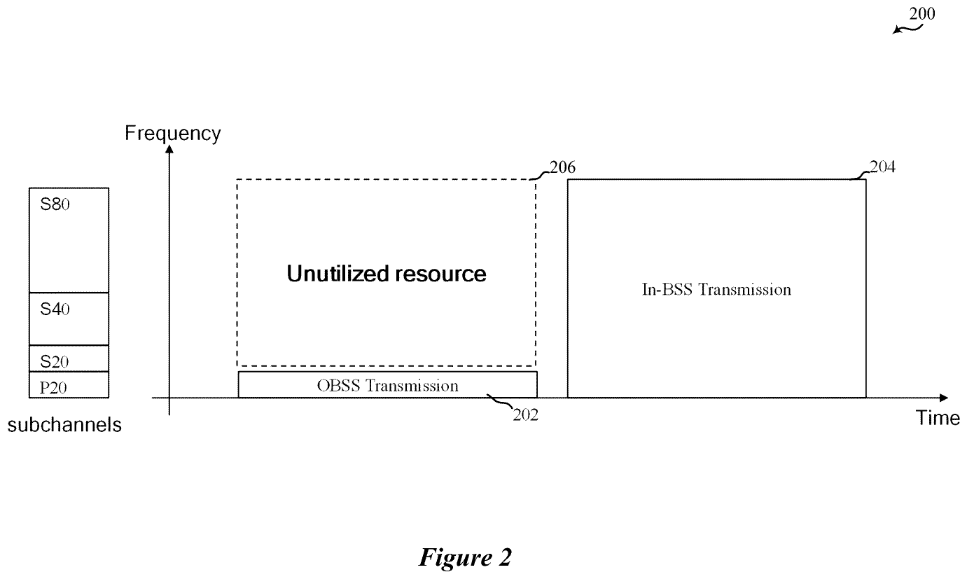

For example, FIG. 2 depicts a diagram 200 for an example bandwidth configuration for a 160 MHz bandwidth, in which the 20 MHz primary channel is labeled P20. A Wi-Fi device contends for access only on the primary channel and access to wider bandwidths (no matter how large) is contingent on access to the primary channel.

Therefore, if an overlapping basic service set (OBSS) STA occupies the primary channel, another (In-BSS) STA may detect an OBSS transmission 202 when performing channel access on the primary channel. Because access to the wider bandwidth (for In-BS transmissions 206) is contingent on access to the primary channel, a remainder of the wide bandwidth 204 remains unutilized, which contributes to lower-throughput and longer latencies.

In some WLAN scenarios, however, a WLAN device may be capable of monitoring additional 20 MHz channel(s) within the operating bandwidth to contend for channel access. In such scenarios, the initial primary channel is referred to as a Main Primary (M-Primary) channel, while an additional 20 MHz channel/subchannel is referred to as an Opportunistic Primary (O-Primary) channel.

Such monitoring for additional 20 MHz channel(s) within the operating bandwidth may be performed sequentially or in parallel. With sequential monitoring, when one 20 MHz primary channel is found Busy, the device switches to another 20 MHz channel to contend for access. When another basic service set (OBSS) transmission is detected on primary channel, the STA may switch to the O-Primary channel and contend for channel access. A STA that supports sequential monitoring may be referred to as a Type-2 device.

With parallel monitoring, the device can monitor multiple 20 MHz channels simultaneously. In some cases, the STA may be capable of detecting preambles and decoding non-HT PPDUs, where such a STA may be referred to as a Type-0 device. In some cases, the STA may be capable of detecting a portion of the 802.11 PPDUs but not capable of decoding PPDUs. Such a STA may be referred to as a Type-1 device.

Certain NPCA STAs (e.g., Type-1 NPCA STAs) may be able to contend and detect incoming packets/PPDUs on multiple primary channels concurrently. However, the STA may be able to transmit or receive 802.11 PPDUs on only one (e.g., NPCA) primary channel at a time.

Thus, if the STAs RBO counts down to zero or if the STA detects a PPDU on a certain primary, then the STA switches to and remains on that primary channel for the duration of the PPDU Tx/Rx. The term “NPCA Primary channel” generally refers to a primary channel (either M-Primary or O-Primary) where an NPCA STA can contend for channel access.

However, once the STA has switched to one primary channel, other events can be triggered on another (e.g., NPCA) primary channel. For example, two packets may be received on different anchors (e.g., at the same time, a small time apart or a large time apart) or the STA may be decoding a packet on one primary while RBO counts down to zero on another primary.

One potential challenge with multi-primary channel access, is how to assign radio resources (and switch between O-primary and/or M-primary channels), when such events are detected. Aspects of the present disclosure provide rules for how NPCA STAs may switch across multiple primary channels when certain events are detected.

Particular aspects of the subject matter described in this disclosure can be implemented to realize one or more of the following potential advantages. In some examples, the described techniques can be used to optimize bandwidth configurations. The techniques disclosed herein allow for bandwidth configurations that may allow multiple STAs to use the same channel for contention, allowing the STAs to detect each other using preamble detection and defer to each other's transmissions. Channel selection performed according to techniques proposed herein may also help mitigate the impact of adjacent channel interference in overlapping BSSs (OBSSs).

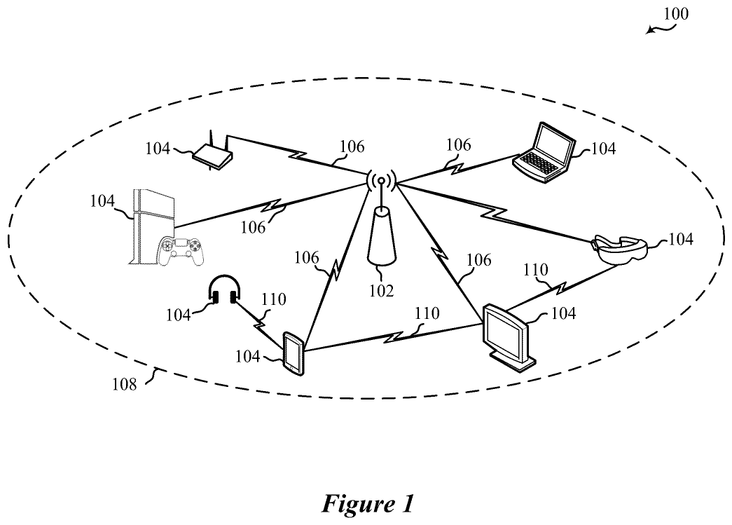

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHZ), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHZ, 80 MHz, 160 MHz, 240 MHz, and 320 MHz while an UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4x80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of the wireless communication network 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

### Overview of Channel Numbering

A primary channel generally refers to a channel that a STA monitors for contention-based channel access. As described above with reference to FIG. 2, in WLANs that support relatively large bandwidths, one 20 MHz channel is designated as a primary channel. This channel may be referred to as primary 20 or, as labeled in FIG. 2, simply P20.

Selection of the bandwidth for the P20 channel typically decides all other channels. For example, in the case of a 160 MHz operating bandwidth, selection of P20 may determine a secondary 20 MHz channel (S20), a primary 40 MHz channel (P40), a secondary 40 MHz channel (S40), a primary 80 MHz channel (P80), and a secondary 80 MHz channel (S80).

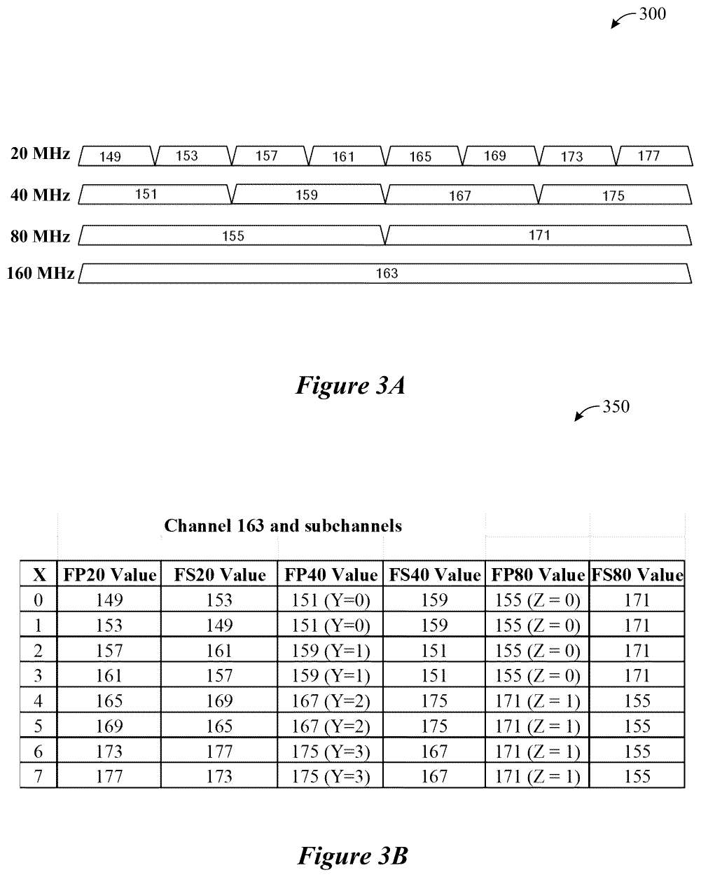

FIGS. 3A and 3B show an example of primary and secondary channel selection for a given channel. Diagram 300 of FIG. 3A shows how the bandwidth of a 160 MHz channel number 163 may be allocated to form different 80 MHz channels (155 and 171), 40 MHz channels (151, 159, 167, and 175), and 20 MHz channels (149, 153, 157, 161, 165, 169, 173, and 177). Particular channel frequencies for these channels may be determined based on a set of equations, determined by the operating bandwidth and a channel selection parameter X.

Table 350 of FIG. 3B shows the possible combinations of channel frequencies for P20, S20, P40, S40, P80, and S80 channels for the 160 MHz bandwidth channel 163 shown in FIG. 3A. As illustrated, selecting the parameter X is essentially the same as choosing the channel frequency for P20. For example, choosing X=1 means P20 is 153 and vice versa, resulting in S20=149, P40=151), S40=159, P80=155, and S80=171.

### Overview of NPCA

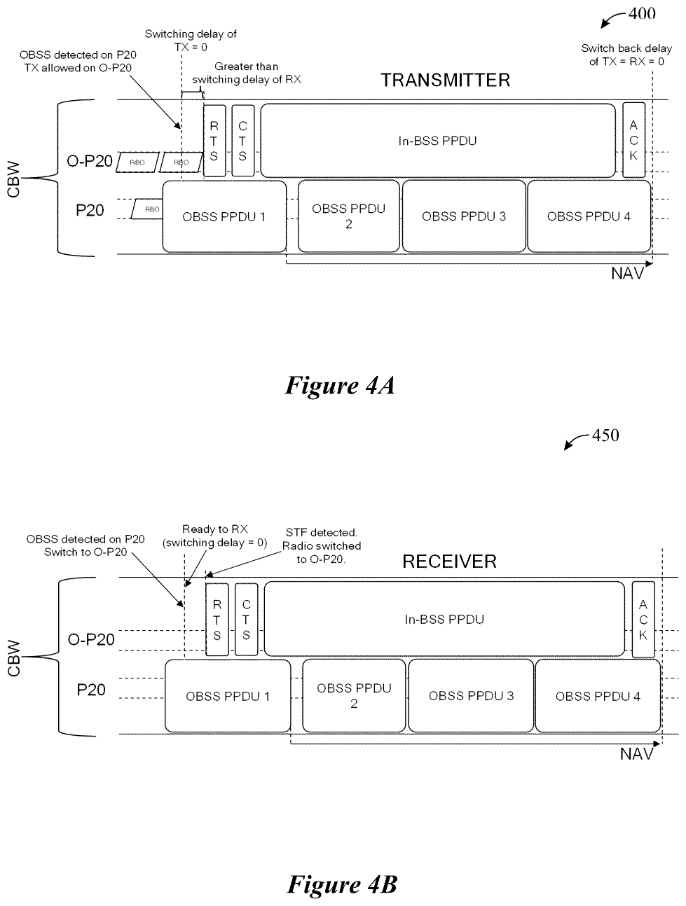

FIG. 4A shows a diagram 400 illustrating an example non-primary channel access (NPCA) STA in a scenario in which transmission is allowed on a non-primary channel (opportunistic primary channel O-P20).

In the illustrated example, while contending for channel access on a first (main) primary channel P20 to send a PPDU, the STA detects an OBSS transmission (PPDU) on P20 (during countdown of a random backoff (RBO) counter. In response, since transmission is allowed on O-P20, the STA switches to O-P20. After contending for (and gaining) access on O-P20, the STA sends an initial control frame (such as request to send (RTS)) and, after receiving the response to the initial control frame (such as a clear to send (CTS)), transmits its (In-BSS) PPDU. As illustrated, the intended recipient may send an acknowledgment (ACK) of receipt of the PPDU.

FIG. 4B shows a diagram 450 illustrating an example non-primary channel access (NPCA) STA in a scenario in which a STA switches to O-P20 for reception.

In the illustrated example, while contending for channel access on P20, the STA again detects an OBSS PPDU on P20. In response, the STA switches to O-P20 and, after a switching delay, is ready to receive on O-P20. After receiving an RTS on O-P20, the STA sends a CTS and receives a PPDU on O-P20. As illustrated, the STA may send an ACK after receiving the PPDU.

### Aspects Related to Rules for Switching of the STAs

Typically, if a PPDU is detected on one (e.g., NPCA) primary channel while a STA is receiving/decoding another PPDU on another (e.g., NPCA) primary channel, the STA may ignore the new PPDU and continue receiving/decoding the ongoing PPDU, or abandon the ongoing PPDU and start receiving/decoding the new PPDU.

Similarly, if an RBO counts down to zero on one (e.g., NPCA) primary channel while the STA is receiving/decoding another PPDU on another primary channel, the STA may defer a transmission on the (e.g., NPCA) primary where RBO counted down to zero and continue receiving/decoding on the other (e.g., NPCA) primary. As an alternative, the STA could decide to abandon reception of the ongoing PPDU and transmit on the (e.g., NPCA) primary where RBO counted down to zero.

As noted above, once a STA has switched (radio resources) to one primary channel, other events can be triggered on another primary channel. For example, two packets may be received on different anchors (e.g., at the same time, a small time apart or a large time apart) or the STA may be decoding a packet on one primary while RBO counts down to zero on another primary.

One potential challenge with multi-primary channel access, is how to assign radio resources (and switch between O-primary and/or M-primary channels), when such events are detected. Aspects of the present disclosure may help address this challenge by providing rules for how STAs that support NPCA may prioritize primary channels when certain events are detected. The techniques proposed herein may apply to devices that support parallel monitoring, where such devices can detect (activity) on multiple primaries concurrently, but can receive only on one primary channel at a time.

As noted above, in certain systems, if a PPDU is detected on one (e.g., NPCA) primary channel while a STA is receiving/decoding another PPDU on another primary channel, the STA may ignore the new PPDU and continue receiving/decoding the ongoing PPDU, or abandon the ongoing PPDU and start receiving/decoding the new PPDU.

Similarly, if an RBO counts down to zero on one primary channel while the STA is receiving/decoding another PPDU on another primary channel, the STA may defer the transmission on the primary where RBO counted down to zero and continue receiving/decoding on the other primary, or abandon the ongoing PPDU and transmit on the primary where RBO counted down to zero.

During such conditions, which action is optimal may depend on various (sometimes competing) considerations: backward compatibility with legacy STAs (that do not support NPCA) and NPCA performance (performance of STAs that support NPCA).

For example, in enabling NPCA, an AP may attempt to avoid (or at least limit) degrading performance of legacy STAs that can reach the AP only on an M-Primary channel. Thus, transmission/reception on M-Primary may be given a higher priority, when legacy STAs are considered. However, while preserving backward compatibility, the performance of NPCA must not be compromised too much (or advances achievable via NPCA may be negated). For such reasons, there may be some ambiguity regarding how to prioritize switching of the STA and how to prioritize different (e.g., NPCA) primary channels.

According to certain aspects, an NPCA STA (communicating/contending) on a first primary channel may detect an event related to a second primary channel. For example, the event may involve detecting a transmission (e.g., an OBSS PPDU) on the second primary channel or the event may involve contending for access on the second primary channel (e.g., detection of RBO expiration). After detecting such an event, the STA may perform one or more actions on at least one of the first primary channel or the second primary channel, where one or more actions performed may be based on at least one prioritization rule being satisfied.

In some cases, prioritization rules for assigning primary channels in NPCA may be based on corresponding priority levels. In some aspects, each primary channel in NPCA has an assigned priority level. In some cases, primary channel assignment may be assigned (and signaled) by an AP STA.

According to certain aspects, if only one O-Primary is defined, an M-Primary may have a higher priority level than the O-Primary (e.g., which may be a relatively common configuration in certain systems that support NPCA).

If more than one O-Primary is defined, an M-Primary may still have the highest priority, and the O-Primary channels may have ordered priority levels assigned. For example, an O-Primary channel that is assigned to (e.g., Type-2) UHR NPCA STAs may be assigned the highest priority level among O-Primary channels (e.g., the second highest priority level after the priority level assigned to the M-Primary).

Among the other O-Primaries (if any), priority ordering may be based on various factors, such as how many NPCA-capable STAs select a certain O-Primary channel (e.g., during association or enablement). For example, if there are three O-Primary channels (O-1, O-2, and O-3) and the number (quantity) of STAs/clients that select O-1 is largest, followed by O-2, and then O-3, then the priority levels may be as follows:
Priority Level of O-1>Priority Level of O-2>Priority Level of O-3.

In some aspects, other factors may result in a change to the priority orders described above. For example, Emergency Preparedness Communication Service (EPCS), when enabled alongside NPCA, may cause an O-Primary channel to have the highest priority (e.g., to ensure channels are available to support emergency/disaster related communications).

Certain aspects of the present disclosure may also provide techniques/rules for prioritizing primary channel selection for receiving, when a STA is currently receiving on a primary channel (e.g., Rx-Rx prioritization).

According to certain aspects, if an NPCA STA is not in a receiving (Rx) state and a new PPDU is detected on another primary channel, then the STA may switch to the primary on which the PPDU is detected. The STA may stay on this channel in order to receive the PPDU.

However, if the NPCA STA is in an Rx state (e.g., is currently decoding another PPDU) on another primary channel, then, what action it takes may depend on whether or not that STA knows (e.g., based on an address in a decoded portion of the PPDU) whether it is the intended recipient of the PPDU.

In some cases, if it is unknown whether the NPCA STA is the intended recipient, the STA may always prioritize the PPDU decoding if it is received on a higher priority primary channel. Thus, if an NPCA STA is receiving/decoding the preamble of the PPDU on O-Primary and a new PPDU arrives on M-Primary, the STA may switch to M-Primary (e.g., and abandon the decoding of PPDU on M-Primary). This approach may help ensure that M-Primary has the highest priority.

On the other hand, if it is known that the NPCA STA is the intended recipient (e.g., the NPCA STA has moved past the PLCP header and MAC header and has determined that the RA of the MPDUs match the NPCA STA's MAC address), then the NPCA STA may prioritize NPCA performance or may follow the priority order of the primary channels.

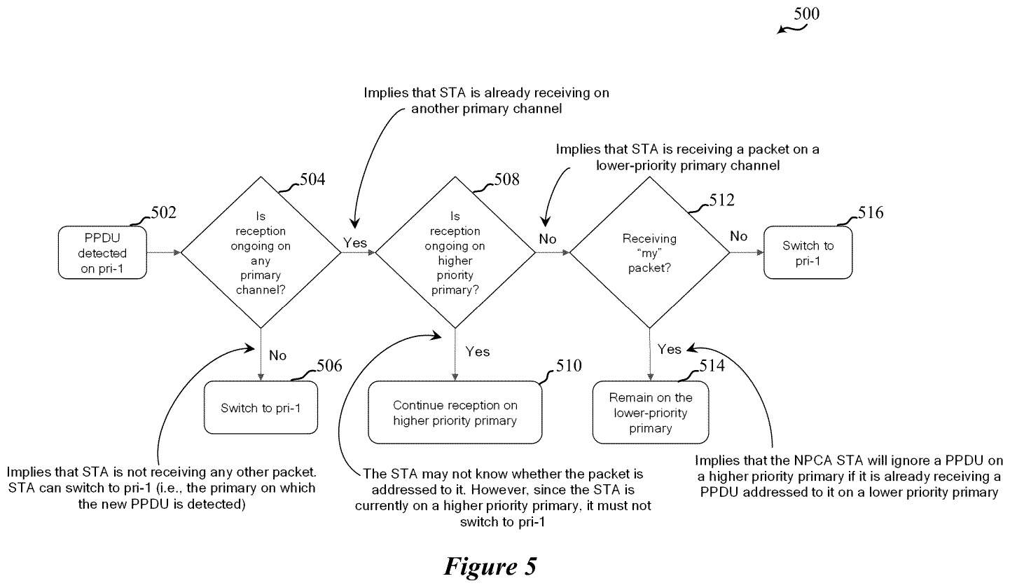

According to first option (e.g., that is designed to prioritize NPCA performance), an NPCA STA may continue decoding MPDUs in an PPDU, even if a new PPDU is detected on a higher priority primary channel. FIG. 5 shows a diagram 500 illustrating an example process prioritizing NPCA performance, in accordance with this first option.

As illustrated at 502, the example assumes the STA detects a PPDU on a first primary channel pri-1. If the STA is not currently receiving on any (other) primary channel when the PPDU is detected (as determined at 504), the STA may simply switch to pri-1, as indicated at 506.

If, on the other hand, the STA is currently receiving on another primary channel when the PPDU is detected, the STA may determine (at 508) if the reception is ongoing on a primary channel that has a higher priority level (than pri-1). If so, the STA may continue reception on the higher priority primary channel (as indicated at 510).

If the reception is not ongoing on a primary channel that has a higher priority level (e.g., the reception is on a primary channel that has a lower priority level than pri-1), the STA behavior may depend on whether the STA knows it is the intended recipient of the packet being received (as indicated at 512).

For example, as indicated at 514, if the STA knows it is the intended recipient of the packet being received, the STA may remain on the lower-priority. In other words, the STA will ignore a PPDU on a higher priority primary channel if it is already receiving a PPDU address to it on a lower priority channel. On the other hand, if the STA does not know it is the intended recipient of the packet being received, the STA may switch to pri-1, as indicated at 516.

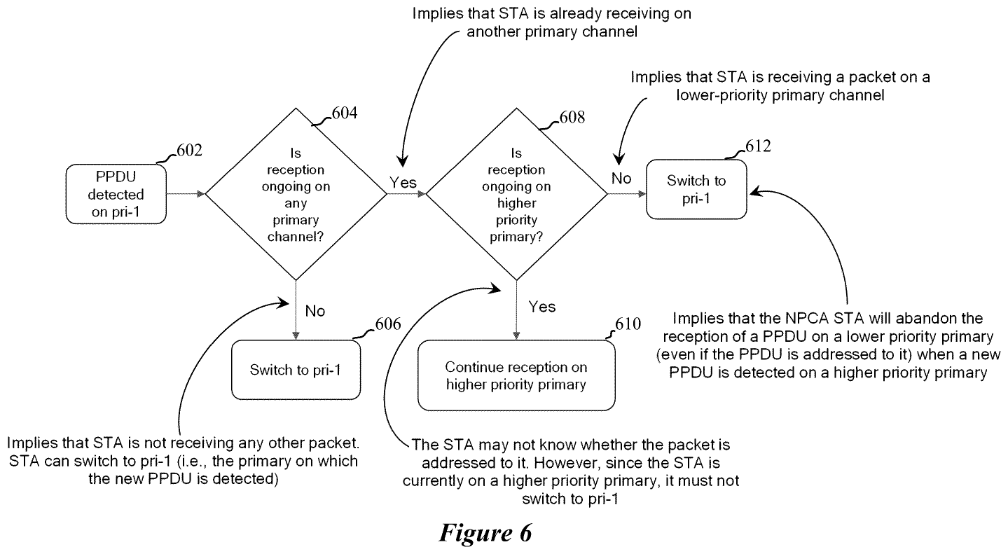

According to second option an NPCA STA may follow a priority order of primary channels and abandon the reception/decoding of the MPDUs in the PPDU and switch to the higher priority channel. FIG. 6 shows a diagram 600 illustrating an example process prioritizing NPCA performance, in accordance with this second option (e.g., which may be applicable to AP-side operations).

As illustrated, operations 602-610 may be the same as operations 502-510 described above. Thus, if a PPDU is detected on pri-1 (at 602) while there is no ongoing reception on another primary channel (as determined at 604), the STA will switch to pri-1 (at 606). If reception is ongoing, but on a higher priority channel (than pri-1), as determined at 608, the STA will continue reception on the higher priority channel (as indicated at 610).

According to this second option, however, if the UE is receiving a packet on a lower priority channel (than pri-1) when it detects a PPDU on pri-1, as determined at 608, the STA switches to pri-1 (as indicated at 612) regardless of whether it knows it is the intended recipient of the packet. In other words, according to this second option, the STA will abandon the reception of a PPDU on a lower priority primary channel (even if it is addressed to the STA) when a new PPDU is detected on a higher primary channel.

According to certain aspects, if the NPCA STA is an AP, it may ignore detected PPDUs on a lower priority primary channel, when one or more higher priority channels are idle.

Certain aspects of the present disclosure may also provide techniques/rules for prioritizing primary channel selection for transmitting, when a STA is currently receiving on a primary channel (e.g., Tx-Rx prioritization).

Aspects of the present disclosure provide various options for when an NPCA STA is receiving on a primary channel and has not yet determined if the PPDU is addressed to the NPCA STA (e.g., has not determined that the PPDU contains MPDUs addressed to the NPCA STA). For example, the different options may involve contention, countdown of EDCA engines, and/or RBO countdown on one or more other Primary channels.

According to certain aspects, contention and/or RBO countdown may continue on (some or) all remaining Primary channels. On the other hand, according to certain aspects, contention and/or RBO countdown may be frozen on (some or) all remaining NPCA Primary channels.

According to certain aspects, whether contention and/or RBO countdown continues or is frozen may depend on primary channel priority levels. For example, in such cases, contention and/or RBO countdown may be frozen on all lower priority NPCA Primary channels, but may continue on higher priority NPCA Primary channel(s).

When a STA is receiving/decoding a PPDU on a Primary channel and at least one MPDU in the PPDU is addressed to the STA, there are various options with respect to the RBO countdown on the other NPCA Primary channel(s). According to certain aspects, contention and/or RBO countdown may be frozen on all remaining NPCA Primary channels. According to certain, contention and/or RBO countdown may continue on all remaining NPCA Primary channels. According to certain, contention and/or RBO countdown may continue on all higher priority NPCA Primary channels, and may be frozen on all lower priority NPCA Primary channels.

In cases where RBO countdown on other (e.g., NPCA) Primary channels is permitted while the STA receives a PPDU (e.g., or a PPDU is being decoded) on one of the (e.g., NPCA) Primary channels, there may be ambiguity regarding the actions of the NPCA STA if the RBO counts down to zero.

According to certain aspects of the present disclosure, STA behavior in this case may depend on whether the STA has determined whether the PPDU is addressed to it. For example, if the STA has not yet determined if it is the intended recipient of the PPDU, the STA may prioritize reception/decoding, if the reception is on a higher priority channel. Otherwise, the STA may prioritize the transmission.

In some cases, if a packet was being received/decoded on M-Primary while RBO is counted down on O-Primary, the STA may prioritize the reception/decoding on M-Primary. However, if a packet is being received/decoded on O-Primary while RBO is counted down on M-Primary, the STA may prioritize the transmission on M-Primary.

In such cases, since the transmitter follows a priority order while transmitting on the primary channels, the chances of receiving a PPDU on a lower priority (e.g., NPCA) primary channel (e.g., O-Primary) may be relatively low if the higher priority (e.g., NPCA) Primary channel (e.g., M-Primary) is Idle.

In some cases, if the STA has determined that it is the intended recipient of the PPDU, the NPCA STA may prioritize the reception/decoding of the remainder of the PPDU.

Certain aspects of the present disclosure may also provide techniques/rules for prioritizing primary channel selection for transmitting, when a STA is currently transmitting on a primary channel (e.g., Tx-Tx prioritization).

For example, since a Type-1 NPCA STA can contend on multiple NPCA Primary channels concurrently, RBO on any of the NPCA Primary channels may count down to zero first. In some systems, by default, if the RBO counts down to zero on M-Primary first, the STA can transmit on the entire bandwidth.

Aspects of the present disclosure, however, provide various options for STA behavior when the RBO counts down to zero on an O-Primary channel first and M-Primary RBO countdown is in progress. For example, in some aspects, the STA may pick a new RBO on the O-Primary channel and may perform another countdown (this option is preferred and most likely). AIFS may also be applied.

According to certain aspects, a STA may be allowed to transmit on the O-Primary and M-Primary channel. This may be feasible, for example, in regulatory domains where the BSS bandwidth can contain multiple contention engines. In some aspects, the transmission should not be within an arbitration inter-frame spacing (AIFS) AIFS of the (transmission on the) other primary channel.

According to certain aspects, a STA may be allowed to transmit on the O-Primary channel without transmitting on the M-Primary channel. One potential issue with this approach is that there will be no visibility of this transmission on the M-Primary channel (e.g., the M-Primary channel will be blind). As a result, in such a scenarios, an AP may need to perform medium sync recovery.

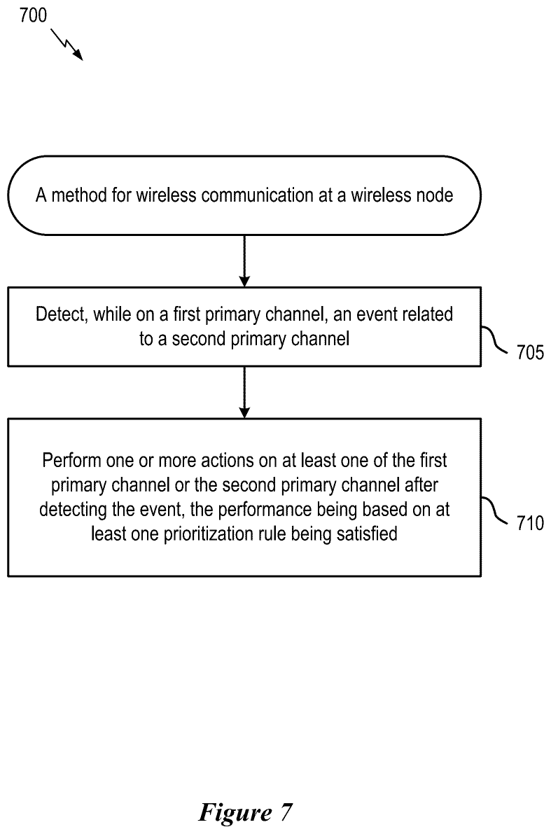

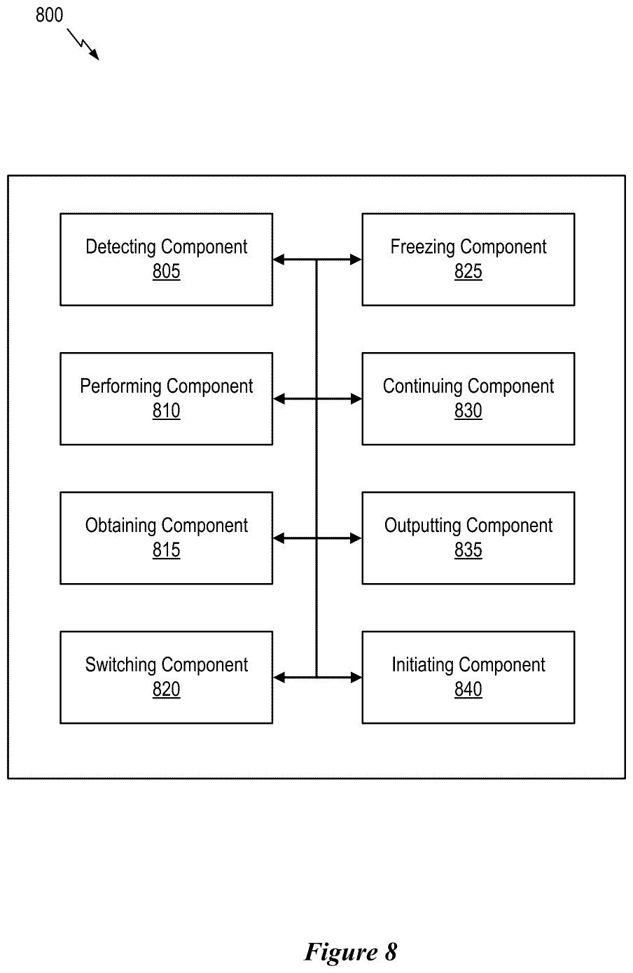

FIG. 7 shows a flowchart illustrating an example process 700 performable by or at a wireless node that supports radio resource assignment (STA switching) according to aspects of the present disclosure. The operations of the process 700 may be implemented by a wireless AP, or its components as described herein, and/or a wireless STA, or its components as described herein. For example, the process 700 may be performed by a wireless communication device, such as the wireless communication device 800 described with reference to FIG. 8, operating as or within a wireless AP and/or a wireless STA. In some examples, the process 700 may be performed by a wireless AP such as one of the APs 102 described with reference to FIG. 1. In some examples, the process 700 may be performed by a wireless STA such as one of the STAs 104 described with reference to FIG. 1.

In some examples, in block 705, the wireless node may detect, while on a first primary channel, an event related to a second primary channel. In some cases, the operations of this step refer to, or may be performed by, a detecting component as described with reference to FIG. 8.

In some examples, in block 705, the wireless node may perform one or more actions on at least one of the first primary channel or the second primary channel after detecting the event, the performance being based on at least one prioritization rule being satisfied. In some cases, the operations of this step refer to, or may be performed by, a performing component as described with reference to FIG. 8.

In some examples, the at least one prioritization rule is satisfied based on the second primary channel having a higher priority level than the first primary channel.

In some examples, the first primary channel comprises an opportunistic primary channel having a first priority level; and the second primary channel comprises a main primary channel having a second priority level higher than the first priority level.

In some examples, the second primary channel comprises an opportunistic primary channel; and different opportunistic primary channels are assigned different priority levels.

In some examples, a priority level assigned to an opportunistic primary channel depends on at least one of: a quantity of wireless nodes that support NPCA assigned to that opportunistic primary channel; whether an emergency communication service is enabled on that opportunistic primary channel; or a type of wireless node that communicates via the opportunistic primary channel.

In some examples, the prioritization rule involves the event being associated with whether a packet is detected via the second primary channel.

In some examples, the at least one prioritization rule is satisfied based on the event of the packet being detected via the second primary channel while the wireless node is not obtaining data on any primary channel.

In some examples, the process 700 further includes obtaining data via the first primary channel, wherein: the packet is detected on the second primary channel while the data is being obtained via the first primary channel, and whether the at least one prioritization rule is satisfied or communication continues to occur via the first primary channel depends, at least in part, on whether the wireless node has learned it is an intended recipient of the packet. In some cases, the operations of this step refer to, or may be performed by, circuitry for obtaining and/or code for obtaining as described with reference to FIG. 8.

In some examples, the at least one prioritization rule is satisfied based on at least one of the wireless node has not learned it is an intended recipient of the packet or the second primary channel has a higher priority level than the first primary channel.

In some examples, the process 700 further includes obtaining data via the first primary channel, wherein: the packet is detected on the second primary channel while the data is being obtained via the first primary channel, and the one or more actions comprise staying on the first primary channel to continue obtaining data on the first primary channel. In some cases, the operations of this step refer to, or may be performed by, circuitry for obtaining and/or code for obtaining as described with reference to FIG. 8.

In some examples, the process 700 further includes obtaining data via the first primary channel, wherein: the packet is detected on the second primary channel while the data is being obtained via the first primary channel, the at least one prioritization rule is satisfied based on the second primary channel has a higher priority level than the first primary channel, and the one or more actions comprise switching to the second primary channel independent of whether the wireless node has learned it is an intended recipient of the packet. In some cases, the operations of this step refer to, or may be performed by, circuitry for obtaining and/or code for obtaining as described with reference to FIG. 8.

In some examples, the prioritization rule involves detection of a packet on the second primary channel; and the one or more actions relate to contention on one or more other primary channels.

In some examples, the one or more actions are further based at least in part on whether the wireless node has learned it is an intended recipient of the packet.

In some examples, the one or more actions comprise at least one of: freezing contention on the one or more other primary channels; continuing contention on the one or more other primary channels; continuing contention on one or more of the other primary channels that have a higher priority level than the second primary; or freezing contention on one or more of the other primary channels that have a lower priority level than the second primary.

In some examples, the one or more actions comprise outputting a packet based on a RBO counter reaches zero on one or the other primary channels that is a main primary channel.

In some examples, the prioritization rule involves contention on the second primary channel; and the one or more actions comprise outputting a packet for transmission based on a RBO counter on the first primary channel or the second primary channel reaches zero.

In some examples, the one or more actions further comprise initiating an additional RBO counter on the first primary channel or the second primary channel.

In some examples, the packet is output for transmission via at least one of a main primary channel or an opportunistic primary channel.

Note that FIG. 7 is just one example of a method, and other methods including fewer, additional, or alternative steps are possible consistent with this disclosure.

FIG. 8 shows a block diagram of an example wireless communication device 800 that supports radio resource assignment (STA switching) according to aspects of the present disclosure. In some examples, the wireless communication device 800 is configured to perform the process 700 described with reference to FIG. 7. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 800 may transmit the information output from the chip. In such an example, the second interface may refer to an interface between the processing system of the chip and a reception component, such that the device 800 may receive information that is passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 800 can be configurable or configured for use in an AP, such as the AP 102 described with reference to FIG. 1. In some other examples, the wireless communication device 800 can be an AP that includes such a processing system and other components including multiple antennas. In some examples, the wireless communication device 800 can be configurable or configured for use in a STA, such as the STA 104 described with reference to FIG. 1. In some other examples, the wireless communication device 800 can be a STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some examples, the wireless communication device 800 also includes or can be coupled with one or more application processors which may be further coupled with one or more other memories. In some examples, the wireless communication device 800 further includes at least one external network interface coupled with the processing system that enables communication with a core network or backhaul network that enables the wireless communication device 800 to gain access to external networks including the Internet.

The wireless communication device 800 includes a detecting component 802, a performing component 810, an obtaining component 815, a switching component 820, a freezing component 825, a continuing component 830, an outputting component 835, and an initiating component 840. Portions of one or more of the components 805, 810, 815, 820, 825, 830, 835, and 840 may be implemented at least in part in hardware or firmware. For example, the components 805, 810, 815, 820, 825, 830, 835, and 840 may be implemented at least in part by a processor or a modem. In some examples, portions of one or more of the components 805, 810, 815, 820, 825, 830, 835, and 840 may be implemented at least in part by a processor and software in the form of processor-executable code stored in a memory.

In some cases, rather than actually transmitting, for example, signals and/or data, the wireless communication device 800 may have an interface to output or provide signals and/or data for transmission (means for outputting or means for providing). For example, a processor may output signals and/or data, via a bus interface, to a radio frequency (RF) front end of the wireless communication device 800 for transmission. In various aspects, the RF front end may include various components, including transmit and receive processors, transmit and receive MIMO processors, modulators, demodulators, and the like.

In some cases, rather than actually receiving signals and/or data, the wireless communication device 800 may have an interface to obtain the signals and/or data received from another device (means for obtaining). For example, a processor may obtain (or receive) the signals and/or data, via a bus interface, from an RF front end of the wireless communication device 800 for reception. In various aspects, the RF front end may include various components, including transmit and receive processors, transmit and receive MIMO processors, modulators, demodulators, and the like.

In various aspects, means for detecting, means for performing, means for obtaining, means for switching, means for freezing, means for continuing, means for outputting, and/or means for initiating may comprise one or more processors (such as the one or more processors/components illustrated in the figures and/or described above).

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

### EXAMPLE CLAUSES

Implementation examples are described in the following numbered clauses.

Clause 1: A method for wireless communication at a wireless node, including: detecting, while on a first primary channel, an event related to a second primary channel; and performing one or more actions on at least one of the first primary channel or the second primary channel after detecting the event, the performance being based on at least one prioritization rule being satisfied.

Clause 2: The method of Clause 1, where: the at least one prioritization rule is satisfied based on the second primary channel having a higher priority level than the first primary channel.

Clause 3: The method of any one of Clauses 1-2, where: the first primary channel includes an opportunistic primary channel having a first priority level; and the second primary channel includes a main primary channel having a second priority level higher than the first priority level.

Clause 4: The method of any one of Clauses 1-3, where: the second primary channel includes an opportunistic primary channel; and different opportunistic primary channels are assigned different priority levels.

Clause 5: The method of Clause 4, where a priority level assigned to an opportunistic primary channel depends on at least one of: a quantity of wireless nodes that support NPCA assigned to that opportunistic primary channel; whether an emergency communication service is enabled on that opportunistic primary channel; or a type of wireless node that communicates via the opportunistic primary channel.

Clause 6: The method of any one of Clauses 1-5, where the prioritization rule involves the event being associated with whether a packet is detected via the second primary channel.

Clause 7: The method of Clause 6, where the at least one prioritization rule is satisfied based on the event of the packet being detected via the second primary channel while the wireless node is not obtaining data on any primary channel.

Clause 8: The method of Clause 6, further including: obtaining data via the first primary channel, where: the packet is detected on the second primary channel while the data is being obtained via the first primary channel, and whether the at least one prioritization rule is satisfied or communication continues to occur via the first primary channel depends, at least in part, on whether the wireless node has learned it is an intended recipient of the packet.

Clause 9: The method of Clause 8, where the at least one prioritization rule is satisfied based on at least one of the wireless node has not learned it is an intended recipient of the packet or the second primary channel has a higher priority level than the first primary channel.

Clause 10: The method of Clause 6, further including: obtaining data via the first primary channel, where: the packet is detected on the second primary channel while the data is being obtained via the first primary channel, and the one or more actions include staying on the first primary channel to continue obtaining data on the first primary channel.

Clause 11: The method of Clause 6, further including: obtaining data via the first primary channel, where: the packet is detected on the second primary channel while the data is being obtained via the first primary channel, the at least one prioritization rule is satisfied based on the second primary channel has a higher priority level than the first primary channel, and the one or more actions include switching to the second primary channel independent of whether the wireless node has learned it is an intended recipient of the packet.

Clause 12: The method of any one of Clauses 1-11, where: the prioritization rule involves detection of a packet on the second primary channel; and the one or more actions relate to contention on one or more other primary channels.

Clause 13: The method of Clause 12, where the one or more actions are further based at least in part on whether the wireless node has learned it is an intended recipient of the packet.

Clause 14: The method of Clause 12, where the one or more actions include at least one of: freezing contention on the one or more other primary channels; continuing contention on the one or more other primary channels; continuing contention on one or more of the other primary channels that have a higher priority level than the second primary; or freezing contention on one or more of the other primary channels that have a lower priority level than the second primary.

Clause 15: The method of Clause 12, where the one or more actions include outputting a packet based on a RBO counter reaches zero on one or the other primary channels that is a main primary channel.

Clause 16: The method of any one of Clauses 1-15, where: the prioritization rule involves contention on the second primary channel; and the one or more actions include outputting a packet for transmission based on a RBO counter on the first primary channel or the second primary channel reaches zero.

Clause 17: The method of Clause 16, where the one or more actions further include initiating an additional RBO counter on the first primary channel or the second primary channel.

Clause 18: The method of Clause 16, where the packet is output for transmission via at least one of a main primary channel or an opportunistic primary channel.

Clause 19: An apparatus, including: at least one memory including executable instructions; and at least one processor configured to execute the executable instructions and cause the apparatus to perform a method in accordance with any one of Clauses 1-18.

Clause 20: An apparatus, including means for performing a method in accordance with any one of Clauses 1-18.

Clause 21: A non-transitory computer-readable medium including executable instructions that, when executed by a processor of an apparatus, cause the apparatus to perform a method in accordance with any one of Clauses 1-18.

Clause 22: A computer program product embodied on a computer-readable storage medium including code for performing a method in accordance with any one of Clauses 1-18.

Clause 23: A wireless node (e.g., an AP or non-AP STA), including: at least one transceiver; at least one memory including executable instructions; and at least one processor configured to execute the executable instructions and cause the wireless node to perform a method in accordance with any one of Clauses 1-18, wherein the transceiver is configured to receive a signal related to the event.

### ADDITIONAL CONSIDERATIONS

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of”′ a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,” or the equivalent in context, whatever it is that is “based on ‘a,” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors configured to execute the computer-executable instructions and cause the apparatus to:
detect, while on a first primary channel, an event related to a second primary channel; and
perform one or more actions on at least one of the first primary channel or the second primary channel after detecting the event, the performance being based on at least one prioritization rule being satisfied.

2. The apparatus of claim 1, wherein:
the at least one prioritization rule is satisfied based on the second primary channel having a higher priority level than the first primary channel.

3. The apparatus of claim 1, wherein:
the first primary channel comprises an opportunistic primary channel having a first priority level; and
the second primary channel comprises a main primary channel having a second priority level higher than the first priority level.

4. The apparatus of claim 1, wherein:
the second primary channel comprises an opportunistic primary channel; and
different opportunistic primary channels are assigned different priority levels.

5. The apparatus of claim 4, wherein a priority level assigned to an opportunistic primary channel depends on at least one of:
a quantity of wireless nodes that support NPCA assigned to that opportunistic primary channel;
whether an emergency communication service is enabled on that opportunistic primary channel; or
a type of wireless node that communicates via the opportunistic primary channel.

6. The apparatus of claim 1, wherein the prioritization rule involves the event being associated with whether a packet is detected via the second primary channel.

7. The apparatus of claim 6, wherein the at least one prioritization rule is satisfied based on the event of the packet being detected via the second primary channel while the wireless node is not obtaining data on any primary channel.

8. The apparatus of claim 6, wherein:
the one or more processors are further configured to cause the apparatus to obtain data via the first primary channel, the packet is detected on the second primary channel while the data is being obtained via the first primary channel; and
whether the at least one prioritization rule is satisfied or communication continues to occur via the first primary channel depends, at least in part, on whether the wireless node has learned it is an intended recipient of the packet.

9. The apparatus of claim 8, wherein the at least one prioritization rule is satisfied based on at least one of the wireless node has not learned it is an intended recipient of the packet or the second primary channel has a higher priority level than the first primary channel.

10. The apparatus of claim 6, wherein:
the one or more processors are further configured to cause the apparatus to obtain data via the first primary channel, the packet is detected on the second primary channel while the data is being obtained via the first primary channel; and
the one or more actions comprise staying on the first primary channel to continue obtaining data on the first primary channel.

11. The apparatus of claim 6, wherein:
the one or more processors are further configured to cause the apparatus to obtain data via the first primary channel, the packet is detected on the second primary channel while the data is being obtained via the first primary channel;
the at least one prioritization rule is satisfied based on the second primary channel has a higher priority level than the first primary channel; and
the one or more actions comprise switching to the second primary channel independent of whether the wireless node has learned it is an intended recipient of the packet.

12. The apparatus of claim 1, wherein:
the prioritization rule involves detection of a packet on the second primary channel; and
the one or more actions relate to contention on one or more other primary channels.

13. The apparatus of claim 12, wherein the one or more actions are further based at least in part on whether the wireless node has learned it is an intended recipient of the packet.

14. The apparatus of claim 12, wherein the one or more actions comprise at least one of:
freezing contention on the one or more other primary channels;
continuing contention on the one or more other primary channels;
continuing contention on one or more of the other primary channels that have a higher priority level than the second primary; or
freezing contention on one or more of the other primary channels that have a lower priority level than the second primary.

15. The apparatus of claim 12, wherein the one or more actions comprise outputting a packet based on a random back off (RBO) counter reaches zero on one or the other primary channels that is a main primary channel.

16. The apparatus of claim 1, wherein:
the prioritization rule involves contention on the second primary channel; and
the one or more actions comprise outputting a packet for transmission based on a random back off (RBO) counter on the first primary channel or the second primary channel reaches zero.

17. The apparatus of claim 16, wherein the one or more actions further comprise initiating an additional RBO counter on the first primary channel or the second primary channel.

18. The apparatus of claim 16, wherein the packet is output for transmission via at least one of a main primary channel or an opportunistic primary channel.

19. A wireless node, comprising:
at least one transceiver;
at least one memory comprising computer-executable instructions; and
one or more processors configured to execute the computer-executable instructions and cause the wireless node to:
detect, based on a signal received via the at least one transceiver, while on a first primary channel, an event related to a second primary channel; and
perform one or more actions on at least one of the first primary channel or the second primary channel after detecting the event, the performance being based on at least one prioritization rule being satisfied.

20. A method for wireless communication at a wireless node, comprising:
detecting, while on a first primary channel, an event related to a second primary channel; and
performing one or more actions on at least one of the first primary channel or the second primary channel after detecting the event, the performance being based on at least one prioritization rule being satisfied.
